(19) United States
(12) Patent Application Publication
(10) Pub. No.: US 2016/0188674 A1
(43) Pub. Date: Jun. 30, 2016

(54) EMOTION-BASED CONTENT RECOMMENDATION APPARATUS AND METHOD

(71) Applicant: Electronics and Telecommunications Research Institute, Daejeon (KR)

(72) Inventor: Mi-Kyong HAN, Daejeon (KR)

(21) Appl. No.: 14/984,925

(22) Filed: Dec. 30, 2015

(30) Foreign Application Priority Data
Dec. 31, 2014 (KR) 10-2014-0195621

(51) Int. Cl. G06F 17/30

(52) U.S. Cl. CPC G06F 17/30528; G06F 17/30598; G06F 17/30312

(57) ABSTRACT

An apparatus and method capable of recommending content suitable for a user using emotion annotation information is provided. The emotion-based content recommendation apparatus includes a content annotation information database (DB) configured to store basic annotation information and emotion information for each content; a user profile information DB configured to store preferred emotion information in addition to basic profile information for each user; and a content recommendation management module configured to recommend a content list suitable for an emotion of a user based on the emotion information for each content and the preferred emotion information for each user.

### CROSS-REFERENCE TO RELATED APPLICATION

This application claims priority to and the benefit of Korean Patent Application No. 2014-0195621, filed on Dec. 31, 2014, the disclosure of which is incorporated herein by reference in its entirety.

### BACKGROUND

1. Field of the Invention

The present invention relates to content recommendation, and more particularly, to an apparatus and method capable of recommending the most suitable content for a user by using emotional annotation information.

2. Discussion of Related Art

There are various content recommendation methods for recommending contents suitable for a user.

A collaborative filtering recommendation method may be a method of configuring a user profile using information to evaluate an item that a user has already experienced, comparing profiles of a plurality of other users given grades on a specific item and a grade of a specific user, setting a user group having similar preference as the nearest-neighbor group, predicting predicted preference of the specific user using the nearest-neighbor group, and recommending content. However, the method is excluded from the recommendation since it is difficult to analyze similarity in a case of new content in which grade information is not generated.

Further, there is a method of recommending by performing inference and classification based on content utilizing an inference function based on topic summary, synonym creation, contexts utilizing a semantic network toolkit configured as a knowledge base by making general common knowledge as a database, but this method is weak in meaningful inference and classification due to content shortage on image content.

Since conventional content methods which currently exist are inadequate for constructing information on new content or information on various contents, there is a problem in which recommendation is performed by being concentrated on content having greater experience points.

Accordingly, a method capable of recommending more optimized content to the user in a functional education service environment is needed.

### SUMMARY OF THE INVENTION

The present invention is directed to an apparatus and method for recommending optimized content considering a personal emotion in a content recommendation service environment in which the personal emotion becomes important like a personal and functional education service environment.

According to one aspect of the present invention, there is provided an emotion-based content recommendation apparatus, including: a content annotation information database (DB) configured to store basic annotation information and emotion information for each content; a user profile information DB configured to store preferred emotion information in addition to basic profile information for each user; and a content recommendation management module configured to recommend a content list suitable for an emotion of a user based on the emotion information for each content and the preferred emotion information for each user.

The emotion-based content recommendation apparatus may further include: an emotion classification feature information DB configured to store mapping information between the emotion information for each content and the preferred emotion information for each user.

The emotion-based content recommendation apparatus may further include: an emotion classification module configured to generate at least one portion of the emotion information for each content, and add the generated emotion information to the content annotation information DB.

The emotion feature classification module may generate at least one portion of the preferred emotion information for each user based on the basic profile information for each user and the emotion classification feature information, and add the generated preferred emotion information to the user profile information DB.

According to another aspect of the present invention, there is provided an emotion-based content recommendation method, including: storing and managing basic annotation information and emotion information for each content; storing and managing basic profile information and preferred emotion information for each user; and recommending a content list suitable for an emotion of a user based on the emotion information for each content and the preferred emotion information for each user.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a structure of emotional content annotation information according to an embodiment of the present invention;

FIG. 2 is a diagram illustrating a structure of emotional user profile information according to an embodiment of the present invention;

FIG. 3 is a block diagram illustrating a configuration of an emotion-based content recommendation apparatus according to an embodiment of the present invention; and

FIG. 4 is a flowchart for describing an emotion-based content recommendation method according to an embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications, and equivalent and alternative forms can be made without departing from the spirit and scope of the invention.

Hereinafter, in the following description with respect to embodiments of the present invention, when a detailed description of known functions or configurations related to the present invention unnecessarily obscures the gist of the present invention, a detailed description thereof will be omitted.

Further, in this specification and claims, the articles “a,” “an,” and “the” are singular in that they have a single referent, but the use of the singular form in the present document should not preclude the presence of more than one referent.

The present invention may recommend optimized content considering a personal emotion of a user by utilizing emotional content annotation information and emotional user profile information.

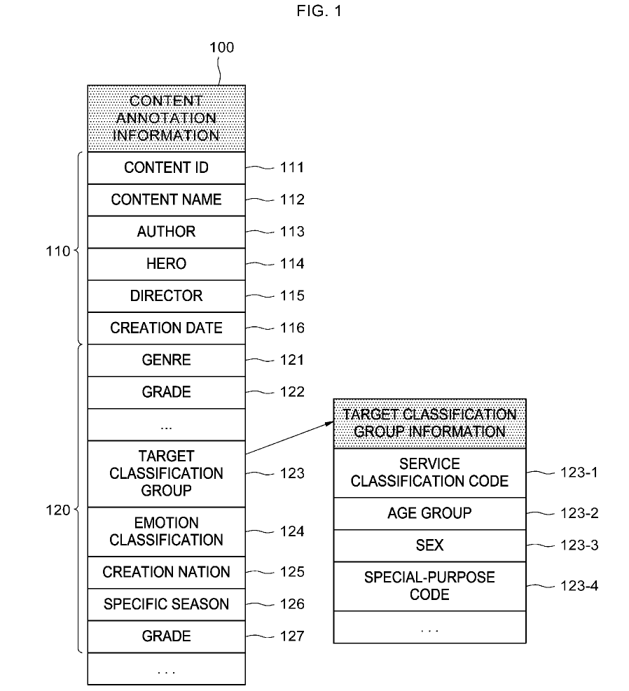

FIG. 1 is a diagram illustrating a structure of emotional content annotation information according to an embodiment of the present invention. As shown, the emotional content annotation information 100 may include emotion information 120 added to basic annotation information 110 on content.

In an embodiment, the basic annotation information 110 may include at least one among a content identification (ID) 111, a content name 112, an author 113, a hero 115, a director 115, a creation date 116, etc.

In an embodiment, the emotion information 120 may include at least one of information such as a content genre 121, a grade 122, a target classification group 123, and an emotion classification 124. The information of the target classification group 123 may be detailed information for content recommendation besides the genre 121 or the grade 122, and include a service classification code 123-1 of science, history, medical, literature, etc., an age group for content provision 123-2 (for example, 0 to 9 years old, 10 to 19 years old, 20 to 29 years old, . . . ), a sex 123-3 (for example, female/male (F/M)), and a special-purpose code 123-4 such as a prenatal education, rehabilitation, functionality, etc.

The information of the emotion classification 124 may be defined as an emotion code (for example, an emotion code such as angry, disgusted, fearful, happy, sad, surprised, neutral, etc. according to the emotion classification of Ekman), and an initial value may be generated using the information such as the genre 121, the grade 122, and the target classification group 123 by the contents recommendation apparatus and method proposed in the present invention, and may be amended according to information which is fed back after the content recommendation.

Further, the emotion information 120 may further include a creation nation 125, information related to a specific season 126 (for example, Christmas, a snowy day, a rainy day, summer, etc.) which is recommended, and information related to a grade 127 updated based on the information which is fed back from the user.

The information related to the grade 127 may be information added by reflecting the feedback information after receiving the basic annotation information on the contents and recommending the content.

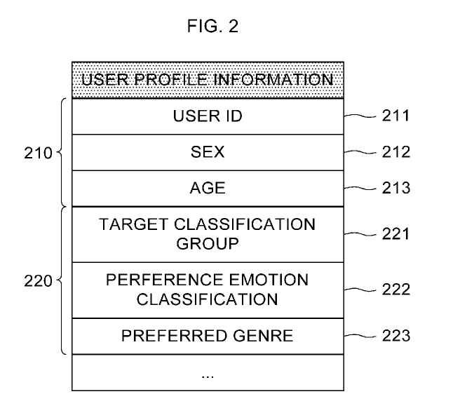

FIG. 2 is a diagram illustrating a structure of emotional user profile information according to an embodiment of the present invention.

In an embodiment, the emotional user profile information 200 may include user basic information 210 including a user ID 211, a sex 212, and an age 213, and user preferred emotion information 220 including a target classification group 221, a preferred emotion classification 222, and a preferred genre 223, etc.

In an embodiment, the information of the target classification group 221 may be information generated by the content recommendation apparatus by considering the sex 212, the age 213, the preferred emotion classification 222 of the user, and an application service, etc., and may be added by the content recommendation apparatus after the user profile information is input from the user.

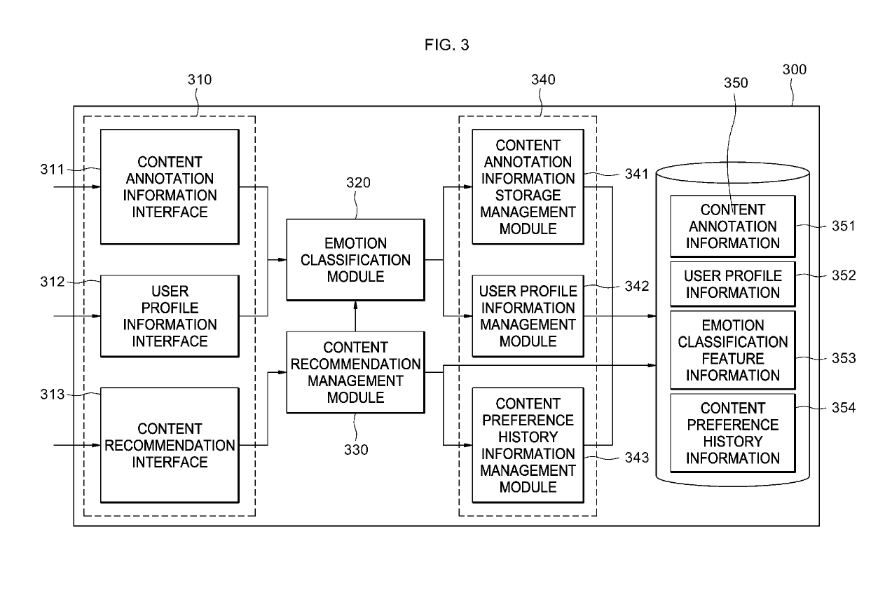

FIG. 3 is a block diagram illustrating a configuration of an emotion-based content recommendation apparatus according to an embodiment of the present invention.

As shown, the emotion-based content recommendation apparatus 300 may include a user interface 310 for content annotation information, user profile information, and the content recommendation, an emotion classification module 320, a content recommendation management module 330, a database (DB) management module 340 for managing a content recommendation DB 350, and the content recommendation DB 350.

The user interface 310 may include a content annotation information interface 311, a user profile information interface 312, and a content recommendation interface 313.

The content annotation information interface 311 may be an interface for a request for addition, change and/or deletion of the content annotation information. When deleting the content annotation information, the deletion may be requested using the information of the content ID 111. Further, the content annotation information which is newly input through the content annotation information interface 311 may be stored in a content annotation information DB 351 through a content annotation information management module 341 after the information of the target classification group, etc. is added through the emotion classification module 320.

The user profile information interface 312 may be an interface for a request of registration (or addition), change, and/or deletion of the user. When deleting the user information, the deletion may be requested using the information of the user ID 211. The user profile information which is newly input through the user profile information interface 312 may be stored in a user profile information DB 352 through a user profile information management module 342 after information of the target classification group, etc. is added through the emotion classification module 320.

The content recommendation interface 313 may be a user interface for a content recommendation request and content recommendation feedback. As an example, when requesting content recommendation optimized for the user for the functional image education service, the content recommendation may be requested through the content recommendation interface 313 using the user profile information.

The emotion classification module 320 may generate at least one portion (for example, the target classification group information) among the content emotion information based on the content basic annotation information, and add the generated emotion information to the content annotation information DB 351. Further, the emotion classification module 320 may generate at least one portion among the preferred emotion information based on the basic profile information for each user, and also add the generated preferred emotion information to the user profile information DB 352.

The content recommendation management module 330 may measure similarity among the genre, the grade, the target classification group, and the emotion classification information of the content annotation information using the target classification group information, the preferred emotion classification information, and the preferred genre information in the user profile information based on the user ID input together with the content recommendation request when the content recommendation is requested through the content recommendation interface 313, select information having the greatest similarity, and select and provide a content list suitable for the emotion of the user by considering the specific season and the grade information.

Further, when the user selects the content in the provided content recommendation list, corresponding information may be transmitted to the content recommendation management module 330 through the content recommendation interface 313. The content recommendation management module 330 may store content preference history information in a content preference history information DB 354 through a content preference history information management module 343, and manage the stored content preference history information.

Moreover, when the education through the image content selected by the user is ended, content recommendation satisfaction information may be fed back from the user through the content recommendation interface 313. The content recommendation management module 330 may amend an emotion classification feature information DB 353 in order to reflect the content recommendation satisfaction information, and change the grade and the emotion classification information, etc. in the content annotation information DB 351 of the corresponding content, and so that a more precise emotion-based content recommendation is achieved when recommending next content.

The DB management module 340 may include the content annotation information storage management module 341, the user profile information management module 342, and the content preference history information management module 343, store information in each of detail DBs of the content recommendation DB 350, and manage the information.

The content recommendation DB 350 may include the content annotation information DB 351, the user profile information DB 352, the emotion classification feature information DB 353, and the content preference history information DB 354.

In an embodiment, the content annotation information DB 351 may be a DB in which the basic annotation information and the emotion information on the content are stored, and a detailed configuration thereof was described with reference to FIG. 1.

In an embodiment, the user profile information DB 352 may be a DB in which the basic profile information and the preferred emotion information for each user are stored, and a detailed configuration thereof was described with reference to FIG. 2.

In an embodiment, the emotion classification feature information DB 353 may be a DB in which the emotion classification feature information used for generating the emotion information for each content and the preferred emotion information for each user is stored.

Emotion classification feature information C113 may manage code values of a variety of feature information for the emotion classification such as emotion classification information A111, target classification group information A110 and B105, a genre A108, a grade A109, a target classification group A110, an emotion classification A111, a specific season A113, and a grade A114, etc. of the content, and manage mapping information so as to properly perform emotion classification on the user profile information or the content annotation information input when adding, deleting, or changing information of each code value. Further, the emotion classification feature information C113 may set a weight value on information such as the target classification group A110, the emotion classification A111, the specific season A113, the grade A114, and the weight value, etc. when performing a similarity analysis for the content recommendation for each user, store the weight value on each information so that the optimized content recommendation is performed by differentiating according to the user group based on the information and performing the similarity measurement, and manage the weight value.

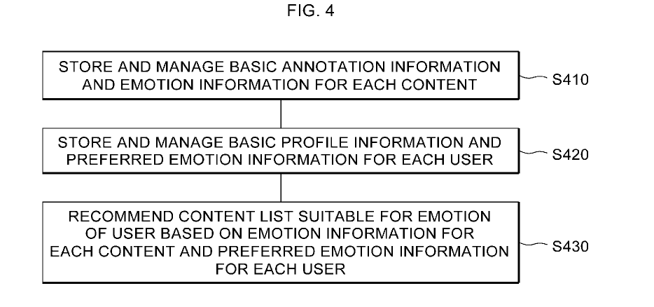

FIG. 4 is a flowchart for describing an emotion-based content recommendation method according to an embodiment of the present invention. In operation S410, the basic annotation information and the emotion information for each content may be stored and managed.

In an embodiment, the basic annotation information and the emotion information for each content may be stored in the content annotation information DB. Here, the basic annotation information for each content may include at least one of information such as the identifier, the content name, the author, the hero, the director, the creation date of the content, and the emotion information for each content may include at least one of information such as the genre, the grade, the target classification group, and the emotion classification information of the content.

In an embodiment, at least one portion of the emotion information may be generated based on the basic annotation information for each content, and added in the content annotation information DB.

In operation S420, the basic profile information and the preferred emotion information for each user may be stored and managed.

In an embodiment, the basic profile information and the preferred emotion information for each user may be stored in the user profile information DB. Here, the basic profile information for each user may include at least one of information such as the identifier, the sex, and the age of the user, and the preferred emotion information for each user may include at least one of information such as the target classification group, the preferred emotion classification, and the preferred genre.

In an embodiment, at least one portion of the preferred emotion information may be generated based on the basic profile information for each user, and added to the user profile information DB.

In operation S430, the content list suitable for the emotion of the user may be recommended based on the emotion information for each content and the preferred emotion information for each user.

Further, when the user selects the content in the provided content list, the selection information may be fed back, and stored and managed as the content preference history information.

Moreover, when the education through the image content selected by the user is ended, the content recommendation satisfaction information may be fed back from the user. The emotion classification feature information DB 353 may be amended based on the contents recommendation satisfaction information, and the grade information and the emotion classification information, etc. in the content annotation information DB 351 of the corresponding content may be changed, and thus a more precise emotion-based content recommendation may be performed when recommending next content.

Meanwhile, the apparatus and method according to an embodiment of the present invention may be recorded in a computer readable medium by being implemented as a program command type which is executable through various types of computer means. The computer readable medium may include a program command, a data file, a data structure, etc. alone or in combination.

The program command recorded in the computer readable medium may be specially designed and configured for the present invention, or may be a command which is well known and used by those of ordinary skill in the computer software field. Examples of the storage medium may be a hardware device which is specially configured to store and execute the program command including a magnetic medium such as a hard disk, a floppy disk, and a magnetic tape, an optical recording medium such as a compact disc-read only memory (CD-ROM) and a digital video disc (DVD), a magneto-optical medium such as a floptical disk, a read only memory (ROM), a random access memory (RAM), or a flash memory. In addition, the medium may be a transmission medium such as optical or metallic lines, waveguides including a carrier waver transmitting signals specifying the program command, a data structure, etc. Examples of the program command may include a device which electronically processes information using an interpreter, etc, for example, high-level language codes which are executable by a computer, as well as machine codes which are made by a compiler.

The hardware devices described above may be configured to be operated by one or more software modules in order to perform an operation of the present invention, and vice versa.

The present invention may be used so that a GigaMedia-based function education service provider recommends the most suitable content to the user. According to the present invention, the emotion information and the recommendation feedback information may be included in the content annotation information, in addition to simple genre or target age information, and the optimized content may be recommended by considering the personal emotion of the user based on the emotion annotation information, and the content suitable for the emotion of the user may be recommended with respect to the content which is newly added or when there is no history information of another user unlike a collaborative filtering method through the similarity analysis.

Further, the content recommendation considering the personal emotion may be performed for the users of the functional education service such as seniors or people with physical or mental handicaps who cannot perform social network service activities.

The present invention is described based on the above-described exemplary embodiments. It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An emotion-based content recommendation apparatus, comprising:
a content annotation information database (DB) configured to store basic annotation information and emotion information for each content;
a user profile information DB configured to store preferred emotion information in addition to basic profile information for each user; and
a content recommendation management module configured to recommend a content list suitable for an emotion of a user based on the emotion information for each content and the preferred emotion information for each user.

2. The emotion-based content recommendation apparatus of claim 1, further comprising:
an emotion classification feature information DB configured to store emotion classification feature information used for generating at least one of the emotion information for each content and the preferred emotion information for each user.

3. The emotion-based content recommendation apparatus of claim 2, further comprising:
an emotion classification module configured to generate at least one portion of the emotion information for each content based on the emotion information for each content and the emotion classification feature information, and add the generated emotion information to the content annotation information DB.

4. The emotion-based content recommendation apparatus of claim 3, wherein the emotion feature classification module generates at least one portion of the preferred emotion information for each user based on the basic profile information for each user and the emotion classification feature information, and adds the generated preferred emotion information to the user profile information DB.

5. The emotion-based content recommendation apparatus of claim 1, wherein the emotion information for each content includes at least one of target classification group information and emotion classification information.

6. The emotion-based content recommendation apparatus of claim 1, wherein the preferred emotion information for each user includes at least one of target classification group information, preferred emotion classification information, and preferred genre information.

7. The emotion-based content recommendation apparatus of claim 1, wherein content information selected from the content list by the user is stored as content preference history information.

8. An emotion-based content recommendation method, comprising:
storing and managing basic annotation information and emotion information for each content;
storing and managing basic profile information and preferred emotion information for each user; and
recommending a content list suitable for an emotion of a user based on the emotion information for each content and the preferred emotion information for each user.

9. The emotion-based content recommendation method of claim 8, further comprising:
storing and managing emotion classification feature information used when generating at least one of the emotion information for each content and the preferred emotion information for each user.

10. The emotion-based content recommendation method of claim 9, further comprising:
generating at least one portion of the emotion information for each content based on the basic annotation information for each content and the emotion classification feature information, and adding the generated emotion information to the content annotation information DB.

11. The emotion-based content recommendation method of claim 9, further comprising:
generating at least one portion of the preferred emotion information for each user based on the basic profile information for each user and the emotion classification feature information, and adding the generated preferred emotion information to the user profile information DB.

12. The emotion-based content recommendation method of claim 8, wherein the emotion information for each content includes at least one of target classification group information and emotion classification information.

13. The emotion-based content recommendation method of claim 8, wherein the preferred emotion information for each user includes at least one of target classification group information, preferred emotion classification information, and preferred genre information.
